(19) United States
(12) Patent Application Publication
(10) Pub. No.: US 2025/0010776 A1
(43) Pub. Date: Jan. 9, 2025

(54) METHOD AND APPARATUS FOR VEHICLE ARMREST

(71) Applicants: MAX AARON JACOBS, BABYLON, NY (US); GARY LAWRENCE JACOBS, SMITHTOWN, NY (US)

(72) Inventors: MAX AARON JACOBS, BABYLON, NY (US); GARY LAWRENCE JACOBS, SMITHTOWN, NY (US)

(21) Appl. No.: 18/218,911

(22) Filed: Jul. 6, 2023

(51) Int. Cl. B60N 2/75

(52) U.S. Cl. CPC B60N 2/787

(57) ABSTRACT

An armrest including a top portion and a bottom portion; and wherein the top portion is substantially rectangular shaped and has a top surface and a bottom surface; and wherein the bottom portion is substantially triangular shaped having a base which abuts and is connected to the bottom surface of the top portion, and a vertex substantially opposite the base. The top portion may include padding. The top portion is preferably elongated and has a length and a width; wherein the length of the top portion is approximately the length of a base of a seat of an automobile, and the width of the top portion is not more than half of the length of the top portion. A method is provided which includes placing such an armrest between an inside of a door of a car and a seat of the car.

### FIELD OF THE INVENTION

This invention relates to armrests.

### BACKGROUND OF THE INVENTION

There are various armrests known in the art, but they are not sufficient.

### SUMMARY OF THE INVENTION

In at least one embodiment an apparatus is provided which includes an armrest including a top portion and a bottom portion; and wherein the top portion is substantially rectangular shaped and has a top surface and a bottom surface; and wherein the bottom portion is substantially triangular shaped having a base which abuts and is connected to the bottom surface of the top portion, and a vertex substantially opposite the base.

The top portion may be comprised of padding.

In at least one embodiment, the top portion is preferably elongated and has a length and a width; wherein the length of the top portion is approximately the length of a base of a seat of an automobile, and the width of the top portion is not more than half of the length of the top portion.

In at least one embodiment a method is provided which includes placing an armrest between an inside of a door of a car and a seat of the car; wherein the armrest includes a top portion and a bottom portion; and wherein the top portion is substantially rectangular shaped and has a top surface and a bottom surface; and wherein the bottom portion is substantially triangular shaped having a base which abuts and is connected to the bottom surface of the top portion, and a vertex substantially opposite the base.

The top portion preferably may be comprised of padding. The top portion is preferably elongated and has a length and a width; and wherein the length of the top portion is approximately the length of a base of a seat of an automobile, and the width of the top portion is not more than half of the length of the top portion.

### BRIEF DESCRIPTION OF THE DRAWINGS

FIG. 1 is a front, left, and top perspective view of a vehicle armrest in accordance with an embodiment of the present invention;

FIG. 2 is a front elevational view of the vehicle armrest of FIG. 1;

FIG. 3 is a rear elevational view of the vehicle armrest of FIG. 1;

FIG. 4 is a left side elevational view of the vehicle armrest of FIG. 1;

FIG. 5 is a right side elevational view of the vehicle armrest of FIG. 1;

FIG. 6 is a top plan view of the vehicle armrest of FIG. 1;

FIG. 7 is a bottom plan view of the vehicle armrest of FIG. 1; and

FIG. 8 is a perspective view of the vehicle armrest inserted between an automobile vehicle seat and a door.

### DETAILED DESCRIPTION OF THE DRAWINGS

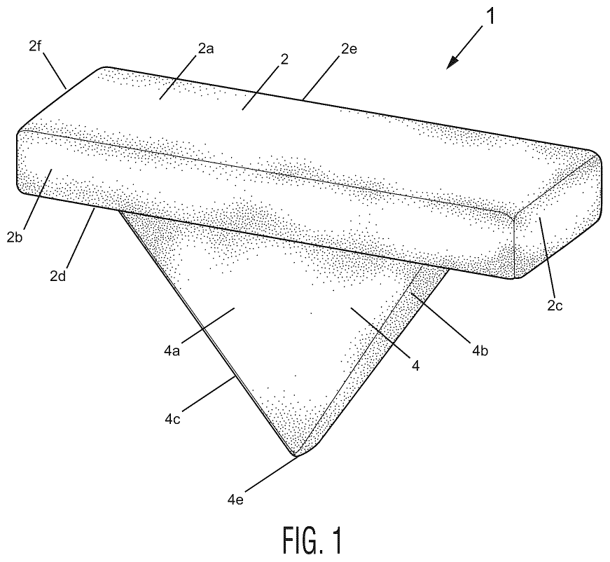

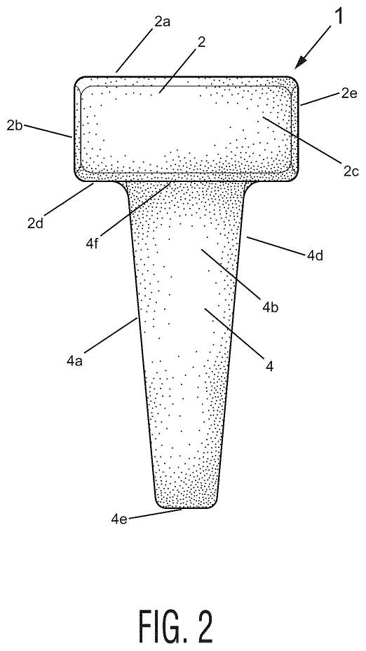

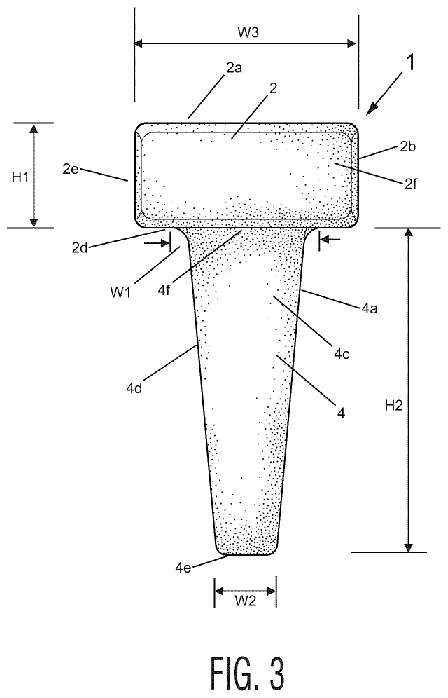

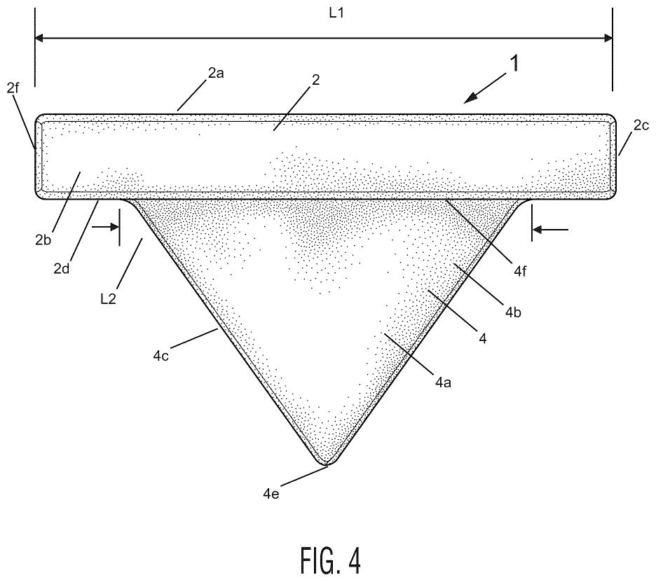

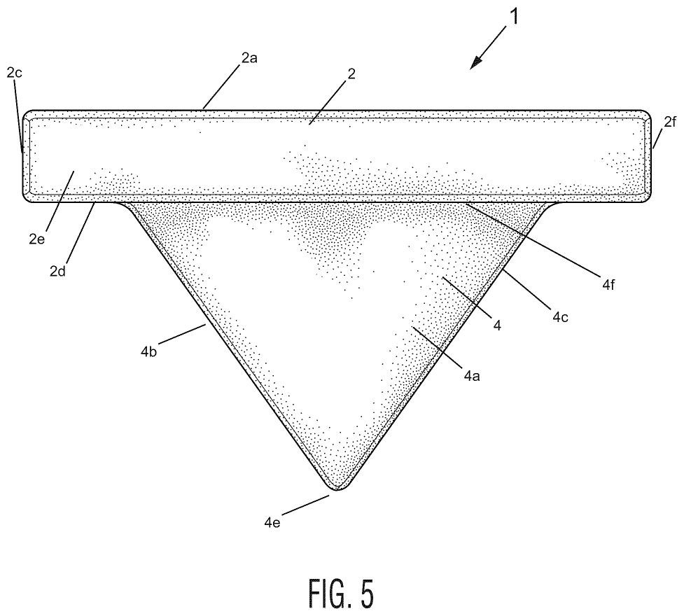

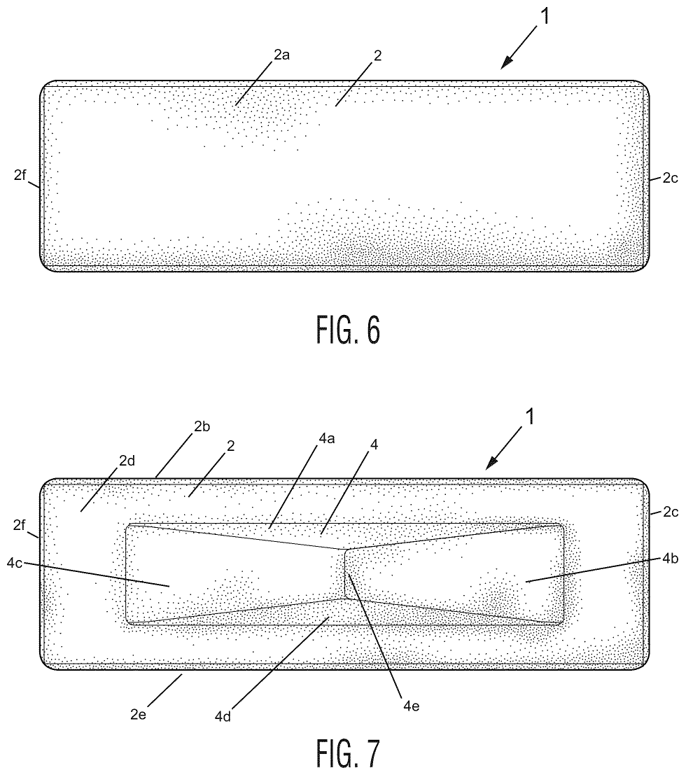

FIG. 1 is a front, left, and top perspective view of a vehicle armrest 1 in accordance with an embodiment of the present invention. FIG. 2 is a front elevational view of the vehicle armrest 1 of FIG. 1. FIG. 3 is a rear elevational view of the vehicle armrest 1 of FIG. 1. FIG. 4 is a left side elevational view of the vehicle armrest 1 of FIG. 1. FIG. 5 is a right side elevational view of the vehicle armrest 1 of FIG. 1. FIG. 6 is a top plan view of the vehicle armrest 1 of FIG. 1. FIG. 7 is a bottom plan view of the vehicle armrest 1 of FIG. 1.

Referring to FIGS. 1-7, the vehicle armrest 1 may include a top section or portion 2 and a bottom section or portion 4.

The top portion 2 may have top surface or side 2a, left side surface or side 2b, front surface or side 2c, bottom surface or side 2d, right surface or side 2e, and rear surface or side 2f. The surfaces or sides 2a-2f may enclose and surround and inner chamber in which is located padding.

The surfaces or sides 2a-2f may define a substantially or exactly rectangular prism shape. However, at the junctions where one surface of 2a-2f, abuts and/or connects with another surface of 2a-2f, the junctions may be rounded, so that a person's arm resting on the armrest 1 or touching the armrest 1, does not touch a sharp surface.

The bottom portion 4 may have a top region 4f, which connects with, is integrated with, and/or abuts the bottom surface 2d of the top portion 2, as shown, for example, in FIGS. 2-5. The bottom portion may also have a left side surface or side 4a, a right side surface or side 4d, a front surface or side 4b, a rear surface or side 4c, and a bottom edge or surface 4e.

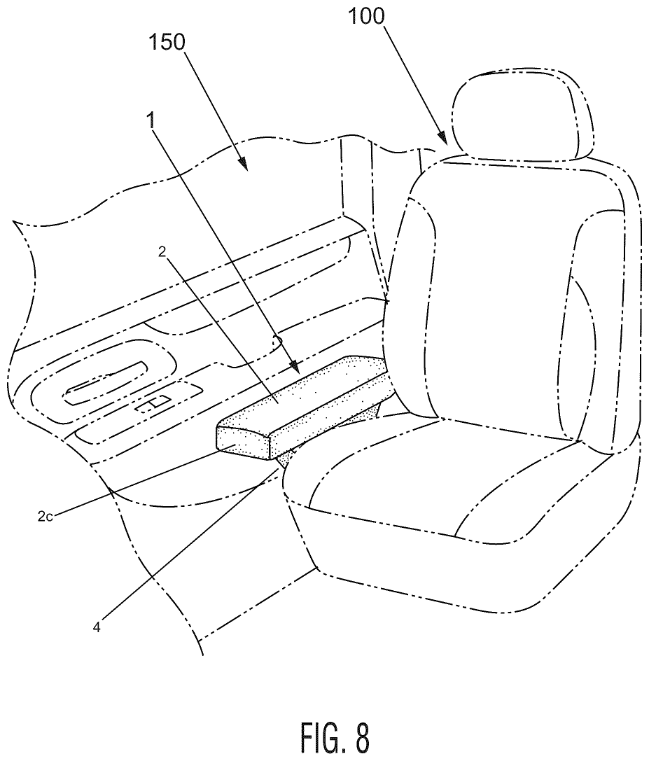

Each of the left side surface or side 4a and the right side surface or 4d is preferably triangular shaped to make the armrest or apparatus 1 easier to fit between a car seat 100 and a car door 150 as shown in FIG. 8. In addition, the left side surface or side 4a and the right side surface 4d preferably come closer together and/or there is a tapering, from the top region 4f to the bottom edge or surface 4e as shown in FIGS. 2-3. This tapering also makes the armrest or apparatus 1 easier to fit between the car seat 100 and the car door 150 as shown in FIG. 8. The portion 4 may taper from a width of W1, which may be twenty-four centimeters, at the top region 4f to a width of W2, which may be five centimeters at the bottom edge or surface 4e as shown in FIG. 3. The top portion 2 may have a width W3, which may be thirty-two centimeters, and a height H1, which may be about sixteen centimeters as shown in FIG. 3. The top portion 2 may have a length L1, which, in at least one embodiment is at least twice the width W3 of the top portion, and which may be about forty-five centimeters, as shown in FIG. 4. The length L1 of the top portion is typically configured to be about the length of a particular substantially horizontal car seat cushion, which is sat on by a human being, such as cushion 102 shown in FIG. 8. In at least one embodiment, different size armrests for armrest 1 are configured with different lengths L1 to match particular types of automobiles.

In at least one embodiment, the region 4f may have a length L2, which may be forty-five centimeters, as shown in FIG. 4, and the length L2 is preferably at least half of the length L1, to provide a secure attachment or integration between top portion 2 and bottom portion 4. Similarly, the width W1 of the region 4f shown in FIG. 2, is preferably at least half of the width W3 of the top portion 2, to provide a secure attachment or integration between top portion 2 and bottom portion 4. In at least one embodiment, the dimensions specified above, of the top portion 2 and the bottom portion 4, are critical to the operation of the armrest or apparatus 1. In at least one embodiment, the perpendicular and shortest distance or height H2, shown in 3 from the bottom surface of the top portion 2 to the bottom of the vertex at location 4e is preferably approximately fifty centimeters and this distance is preferred to provide a secure insertion of the portion 4 between a car seat and the inside of a car door, and to permit the top portion 2 to be situated and oriented in a manner to allow a person sitting in the car seat to comfortably rest their arm on the top surface 2a of the top portion 2.

In operation, a human being would take the armrest or apparatus 1, and insert the edge 4e between the car seat 100 and the car door 150 so that a substantial portion of the bottom portion 4 becomes wedged between the car seat 100 and the car door 150, with the portion 2 sitting above a car seat horizontal cushion 102 (which is sat on by the human being), as shown in FIG. 8. The car seat 100 includes a substantially vertical cushion 104, which is substantially perpendicular to the portion 2, but which typically can be inclined and/or altered in angle with respect to the portion 2. When in the position and orientation shown in FIG. 8, a human being can rest their hand, wrist, and/or forearm, on the top surface 2a The armrest or apparatus 1, can be removed from the location shown in FIG. 8, and stored until further use.

In at least one embodiment of the present invention, the armrest or apparatus 1 is entirely covered on all exterior surfaces with an integrated cotton pillow case. Concealed within the cotton pillow case, in at least one embodiment, is a memory foam.

In at least one embodiment, when the armrest or apparatus 1 is in use as in FIG. 8, the armrest 1 is preferably configured to avoid obstructing or blocking any airbag in an automobile that may be deployed upon a collision.

The armrest or apparatus 1 is particularly useful to serve drivers and passengers that drive long distances or have medical conditions such as tendinitis, arthritis, or other orthopedic problems.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

We claim:

1. An apparatus comprising:
an armrest including a top portion and a bottom portion; and
wherein the top portion is substantially rectangular shaped and has a top surface and a bottom surface;
and wherein the bottom portion is substantially triangular shaped having a base which abuts and is connected to the bottom surface of the top portion, and a vertex substantially opposite the base.

2. The apparatus of claim 1 wherein
the top portion is comprised of padding.

3. The apparatus of claim 1 wherein
the top portion is elongated and has a length and a width;
wherein the length of the top portion is approximately the length of a base of a seat of an automobile, and the width of the top portion is not more than half of the length of the top portion.

4. A method comprising the steps of:
placing an armrest between an inside of a door of a car and a seat of the car;
wherein the armrest includes a top portion and a bottom portion; and
wherein the top portion is substantially rectangular shaped and has a top surface and a bottom surface;
and wherein the bottom portion is substantially triangular shaped having a base which abuts and is connected to the bottom surface of the top portion, and a vertex substantially opposite the base.

5. The method of claim 4 wherein:
the top portion is comprised of padding.

6. The method of claim 4 wherein
the top portion is elongated and has a length and a width; and
wherein the length of the top portion is approximately the length of a base of a seat of an automobile, and the width of the top portion is not more than half of the length of the top portion.
